(19) United States
(12) Patent Application Publication
(10) Pub. No.: US 2007/0115132 A1
(43) Pub. Date: May 24, 2007

(54) Tagging and communication system and methods for use therewith

(75) Inventors: Jason August, Toronto (CA); Paul Waterhouse, Selkirk (CA); John K. Stevens, Stratham, NH (US)

Correspondence Address: Oppedahl Patent Law Firm LLC - VAI, P.O. BOX 4850, FRISCO, CO, 80443-4850, US

(73) Assignee: Visible Assets, Inc., Mississauga (CA)

(21) Appl. No.: 11/423,509

(22) Filed: Jun. 12, 2006

Related U.S. Application Data
(60) Provisional application No. 60/595,156, filed on Jun. 10, 2005.
(60) Provisional application No. 60/707,218, filed on Aug. 10, 2005.
(60) Provisional application No. 60/725,334, filed on Oct. 2, 2005.
(60) Provisional application No. 60/596,527, filed on Oct. 3, 2005.
(60) Provisional application No. 60/744,524, filed on Apr. 10, 2006.

(51) Int. Cl. G08B 13/14

(52) U.S. Cl. 340/572.8; 340/572.7

(57) ABSTRACT

A circular data-bearing medium having a hub hole has a chip and two distinct loop antennas, each offset from the other, each antenna disposed around the hub hole, the chip electrically connected with each of the two distinct antennas. The circular data-bearing medium does not have a battery. When bathed in RF energy the chip receives power from one of the loop antennas. During the power-up time the chip may receive messages on the other of the loop antennas, and may respond, on that antenna, to some of the received messages and not others, based upon internal states within the chip. At least one of the internal states is reset upon loss and restoration of the bathing RF energy. When passed nearby to an EAS sensor, for example at an exit of a store, the chip can selectively either trigger the sensor or not trigger the sensor, as a function of whether an EAS link has or has not been blown, and the triggering response is non-identical from one data-bearing medium to the next.

### CROSS-REFERENCE TO RELATED APPLICATIONS

This application claims the benefit of U.S. application No. 60/595,156, filed Jun. 10, 2005, U.S. application No. 60/707,218, filed Aug. 10, 2005, U.S. application No. 60/725,334, filed Oct. 2, 2005, U.S. application No. 60/596,527, filed Oct. 3, 2005, U.S. application No. 60/744,524, filed Apr. 10, 2006, and U.S. application No. 11/419,750, filed May 22, 2006, each of which is hereby incorporated herein by reference for all purposes.

### BACKGROUND

It is not easy to keep track of stock in a retail store, to detect shoplifting, and to perform “area reads” of visibility tags. Some approaches are expensive.

An “area read” means a successful reading of a multiplicity of tags in a particular area, using an antenna that may be some feet away from some of the tags, and without making use of any physical movement of the antenna during this successful reading.

To have an appreciation of how difficult an “area read” can be, consider that with some tag technologies, such as traditional RFID chips, all chips that are within the reading path of the antenna will respond. This leads to collisions among the responses. Given this problem, many system designers will choose to ensure, a priori, that only one RFID chip will be within the reading path of the antenna. This may be accomplished by choosing RF power levels and antenna configurations that only “talk to” one RFID chip at a time. In such a system, the only way to read a large number of tags is to move the reading antenna from place to place until it has read all of the tags, or to move the RFID chips around from place to place until each one has been put in close proximity to the reading antenna. Such technologies are antithetical to “area reads”.

In a retail store, if a traditional RFID chip solution were being employed, then the process of conducting an inventory (by means of RFID chips) would require either (a) physically moving each inventory item one by one to be nearby to a reader, and then moving each such item away from the reader, so that the items can be read one at a time; or (b) physically moving a reader from place to place until it had successively been positioned nearby to each inventor item seriatim, or (c) some combination of these two approaches. Such approaches are time- and labor-intensive. It is easy to imagine such an inventory taking at least a few seconds per inventory item, and for some items, as much time as a minute or more per item.

It would be extremely desirable if a tagging system could be devised which would permit “area reads” so that the contents of a store could be inventoried without the need for physically manipulating reading antennas or physically manipulating inventory items. It would be desirable if such a system could permit localizing particular items to particular local areas within the store.

As mentioned above, another system concern is the ability to perform Electronic Article Surveillance (EAS), meaning detection of shoplifting. It is commonplace to provide EAS devices in small, expensive items of merchandise. A variety of technologies are commonly employed. The EAS device responds to sensors located near store exits, emitting or absorbing or reflecting energy in a way that permits detection of the EAS device as it approaches the door, presumably on the person of a shoplifter. When a customer purchases an item of merchandise, the EAS device is removed or is deactived. Deactivation may involve exposing the EAS device to a strong magnetic field, or to strong RF energy at a particular frequency, for example. This permits the consumer to leave the store with the purchased item without triggering an alarm.

FIG. 5 shows a portion of a building 61 including Electronic Article Surveillance (EAS) equipment 59 adjacent to a door 60. The EAS equipment 59 typically includes one or more transmitters which emit RF energy at some particular first frequency. The equipment 59 also includes one or more receivers tuned to detect RF energy (if any) that is present at some other particular second frequency. Items of merchandise will each be tagged with an EAS tag. A typical EAS tag is a device which is resonant at the first frequency, meaning that it is able to absorb some of the RF energy. The device is designed to re-emit some of the energy at the second frequency, typically because of incorporation of some nonlinear device that causes emission of energy at the second frequency.

In this way, if a tagged article passes nearby to the equipment 59, energy is detected by the receiver. This detected energy, when in excess of some threshold, causes an audible alarm. A would-be shoplifter may thus be detected and averted.

Merchandise that is paid for should not, of course, trigger the audible alarm. To bring about this result, the cashier location has a deactivating device that is used to deactivate the EAS tag. After the EAS tag has been deactivated, then it can pass through the door 60 without triggering an audible alarm from the equipment 59. The way of deactivating a tag depends on the design of the particular EAS system. For some EAS tags, the way to deactivate the tag is to expose it to a high-gauss fixed magnetic field. The field deforms elements within the tag so that it no longer resonates or no longer re-emits RF energy. For other EAS tags, the way to deactivate the tag is to expose the tag to a high-strength RF field at a particular frequency. The field causes current to flow in the tag, and the current is high enough to burn a fusible link within the tag. The design of the tag is such that once the link is broken, the tag no longer resonates or no longer re-emits RF energy.

Heretofore, however, there has not been any commercially successful approach that provides both EAS functionality as well as area visibility of individual items. Past EAS devices have been designed in a way that leads to each EAS device responding identically to all other devices. The sensor at the door only knows that an item is being shoplifted, but does not know whether it is music by Madonna or by Norah Jones. As a consequence, in the past, if it has been desired to identify particular items of merchandise (for example by means of RFID chips) then that has been accomplished only by means that are quite distinct from the EAS means.

It would be desirable to have a single approach providing both EAS functions as well as item-specific responses to visibility queries.

It would also be desirable to have affinity programs that would permit, for example, opting in by a customer to the opportunity to carry a badge or card connecting the customer to the affinity program. It would be desirable if such a badge or card could be responsive to and communicative with the same “area read” system that would be so desirable in a retail environment.

### SUMMARY OF THE INVENTION

A circular data-bearing medium having a hub hole has a chip and two distinct loop antennas, each offset from the other, each antenna disposed around the hub hole, the chip electrically connected with each of the two distinct antennas. The circular data-bearing medium does not have a battery. When bathed in RF energy the chip receives power from one of the loop antennas. During the power-up time the chip may receive messages on the other of the loop antennas, and may respond, on that antenna, to some of the received messages and not others, based upon internal states within the chip. At least one of the internal states is reset upon loss and restoration of the bathing RF energy. When passed nearby to an EAS sensor, for example at an exit of a store, the chip can selectively either trigger the sensor or not trigger the sensor, as a function of whether an EAS link has or has not been blown, and the triggering response is non-identical from one data-bearing medium to the next.

### DESCRIPTION OF THE DRAWING

The invention will be described with respect to a drawing in several figures.

FIG. 1 shows a passive communications device (PCD) according to the invention.

FIG. 1.1 shows a functional block diagram of a PCD according to the invention using a 3-terminal IC.

FIG. 1.2 shows a simulation wiring schematic of a portion of FIG. 1.1.

FIG. 1.3 shows an example of relative voltage of L1 and L2 in accordance with the wiring diagram FIG. 1.2.

FIG. 2 shows a plastic case for a CD-ROM or Compact Disk (CD) or Digital Video Disk (DVD), along with a disk and an optional PCD.

FIG. 3 shows a disk such as is shown in FIG. 2, in greater detail, including PCD circuitry.

FIG. 4 shows a tagging and communication system according to the invention, including disks such as shown in FIG. 3.

FIG. 4.1 shows a functional block diagram of the converter 48 according to the invention.

FIG. 5 shows a portion of a building including Electronic Article Surveillance (EAS) equipment adjacent to a door.

### DETAILED DESCRIPTION

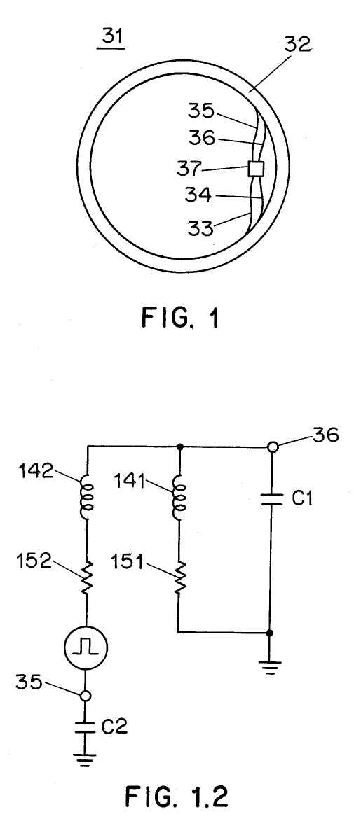

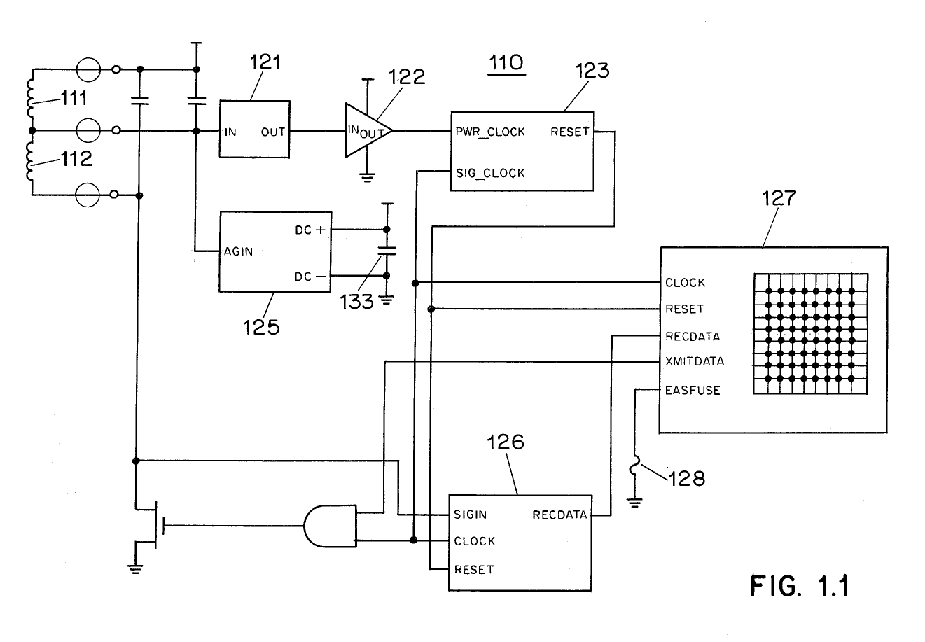

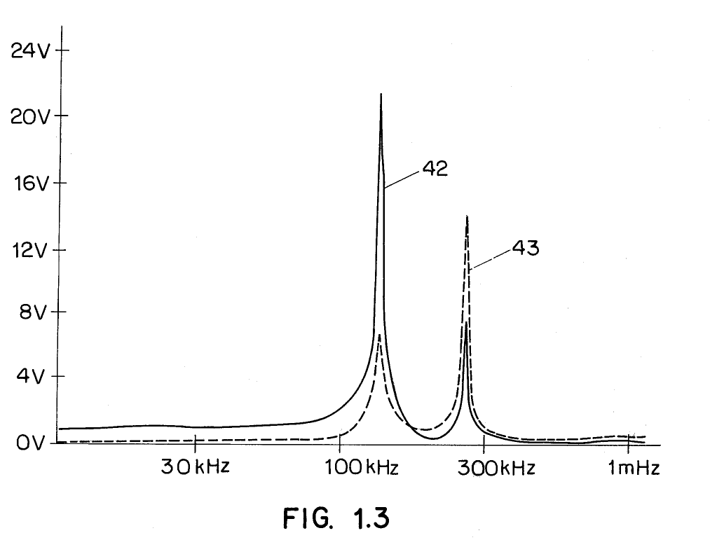

FIG. 1 shows a passive communications device (PCD) according to the invention. The device has a loop antenna 32 made of typically 500 turns of fine-gauge copper wire (the copper wire being typically 0.001 in diameter). Also shown is an integrated circuit (IC) 37 which is connected to the antenna 32 by means of leads 33, 34, 35 and 36.

In this embodiment the IC 37 is a four-terminal device. The antenna 32 is actually two antennas, with some of its turns allocated to one antenna and connected to the IC 37 by two of the leads (e.g. leads 33, 35), and with the rest of its leads allocated to a second antenna and connected to the IC 37 by the remaining two of the leads (e.g. leads 34, 36). Typically ⅓ of the turns are used for the first antenna and the remaining ⅔ turns are used for the second antenna. In an exemplary embodiment the antennas are offset from each other so as to reduce their mutual coupling.

FIG. 1.1 shows a functional block diagram for the iDot PCD 110 according to the invention using a 3-terminal IC. The device as shown has two antenna loops 111 and 112. Antenna loop 111 is the power antenna and uses ⅓ of the total turns. Antenna loop 112 is the Communication loop and uses ⅔ of the total turns. 111 is tuned by capacitor C1. 112 is tuned by capacitor C2. It is contemplated that the ratio of turns of 111:112 of 1:2 is preferred to produce the necessary tuning difference between 111 and 112 thereby allowing 111 and 112 to resonate at two different frequencies, at a factor of 2 in this embodiment. It is understood that alternative ratios of 1:4, 1:3, etc. may be employed in the case of using different Dividers 123. 111 feeds signal to power channel rectifier 125 which drives storage capacitor 133 and powers the rest of the circuit. 111 also feeds signal to a filter 121 that removes any residual communications signal resulting in a signal fed to amplifier 122. 122 outputs a digital clock signal labeled PWR_CLOCK to 123. 123 detects presence of the PWR_CLOCK signal to provide a reset function RESET to logic 127 and receiver 126. 123 also divides PWR_CLOCK signal into SIG_CLOCK to drive the Communications functions at 126 and logic functions at 127. 112 also feeds communications signal to 126 at SIGIN which is processed into digital data and output at RECDATA to logic block 127 at RECDATA. 127 provides logic functions including checking ID and generating ID and generating EAS code. 127 outputs XMTDATA to AND gate together with signal CLOCK to generate a pulse modulation back to 122.

It is understood that different divider ratios other than 2 may be used in divider 123. Alternatively, the communication Frequency may be higher than the Power Frequency requiring a frequency multiplier circuit.

FIG. 1.2 shows an equivalent circuit to that of FIG. 1.1, simplified to provide insight, in a circuit simulation, as to the energy developed in the circuit at various frequencies. Inductors 141 and 142 correspond to the inductive antennas in FIG. 1.1. Resistors 152, 152 are selected to correspond to the loads on the coils. 142 is typical 5 mH and 141 is typical 1.5 mH, as in FIG. 1.1.

FIG. 1.3 shows the predicted voltages in the two coils as a function of imposed RF energy. Line 42 shows the voltage at 142, the data signal, while line 43 shows the voltage at 141, the power signal. As may be seen, at about 130 kHz the data signal reaches a peak at about 20 volts while the power signal is much lower, perhaps 7 volts. As may be seen, at about 260 kHz the data signal reaches a peak at about 8 volts while the power signal is much stronger, perhaps reaching 13 volts. In this way, power and data are selectively coupled to a tag.

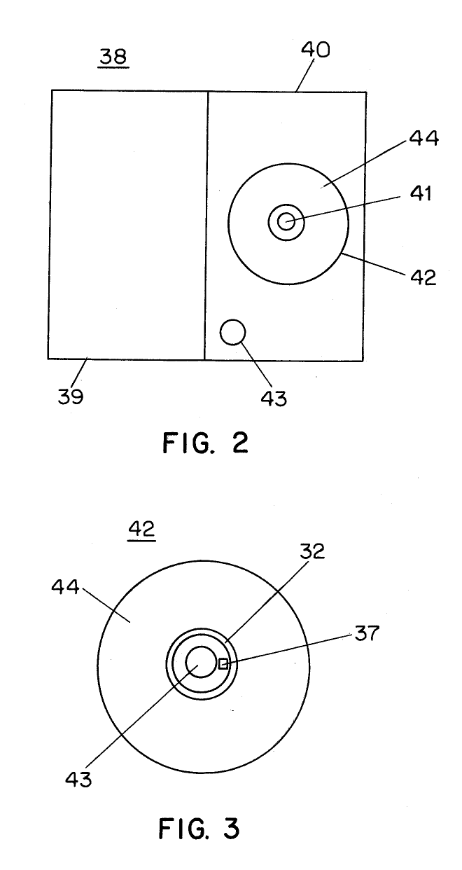

FIG. 2 shows a plastic case 38 for a CD-ROM or Compact Disk (CD) or Digital Video Disk (DVD), along with a disk 42 and an optional PCD 43. The case 38 has a front cover 39 and a back cover 40. The back cover 40 has a spindle 41 which mates with the disk 42 to hold it into place. The disk 42 may optionally contain a PCD 43. This is discussed in more detail with respect to FIG. 3.

FIG. 3 shows a disk such as is shown in FIG. 2, in greater detail, including PCD circuitry 44. Disk 42 is shown. The disk 42 has a data-writing area 44, which may carry data formatted to serve as data for a DVD, for a music CD, or for a data CD-ROM. Antenna area 32 may be seen, as well as hole 43 which is sized to fit onto the spindle 41 in FIG. 2. Importantly, disk 42 also has embedded within it an IC 37. Thus, the disk 42 as shown in FIG. 3 contains everything that was previously shown and discussed in FIG. 1. In this way the disk 42 has embedded within it an entire PCD serving the same functions as the PCD of FIG. 1.

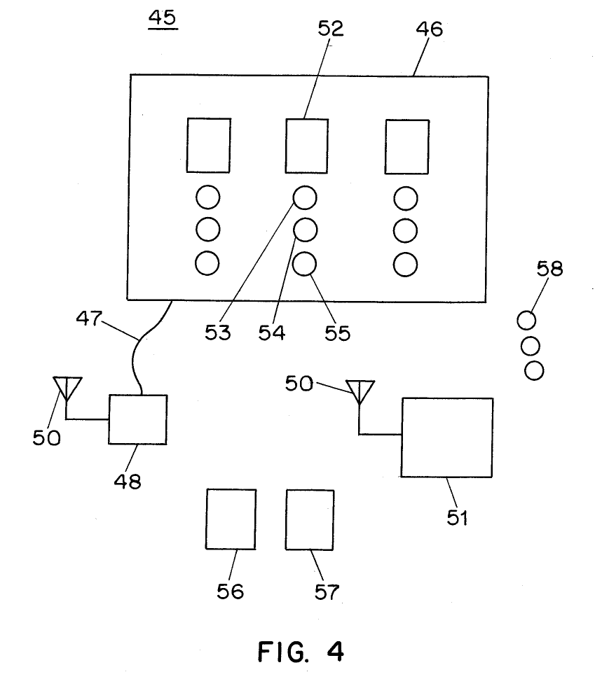

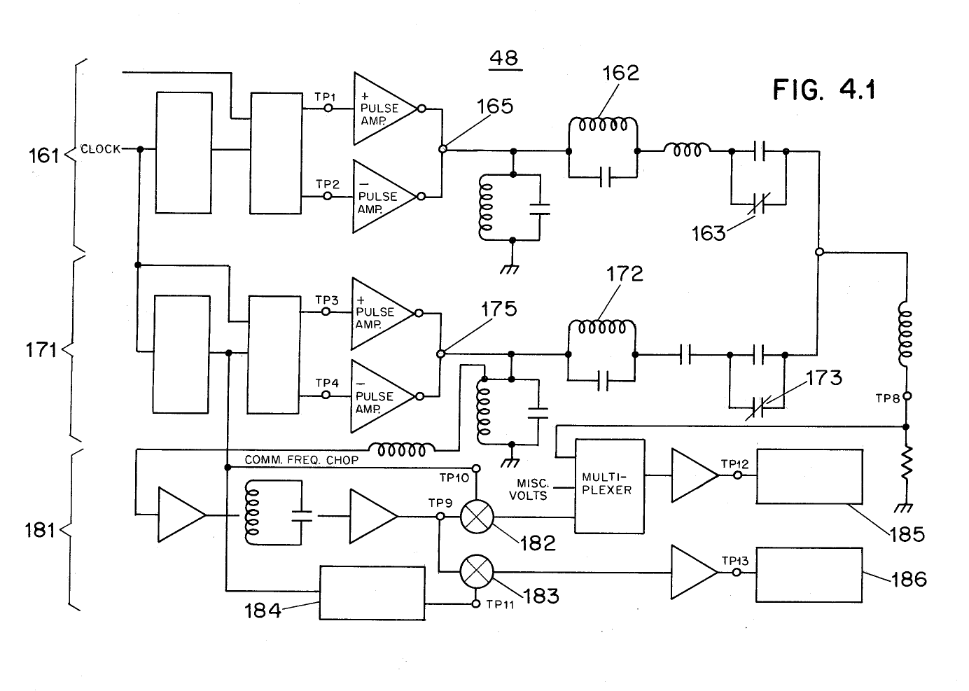

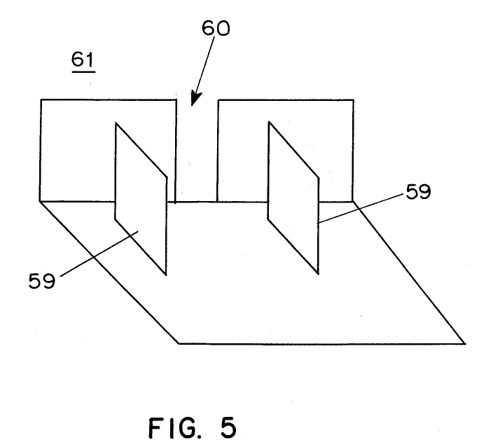

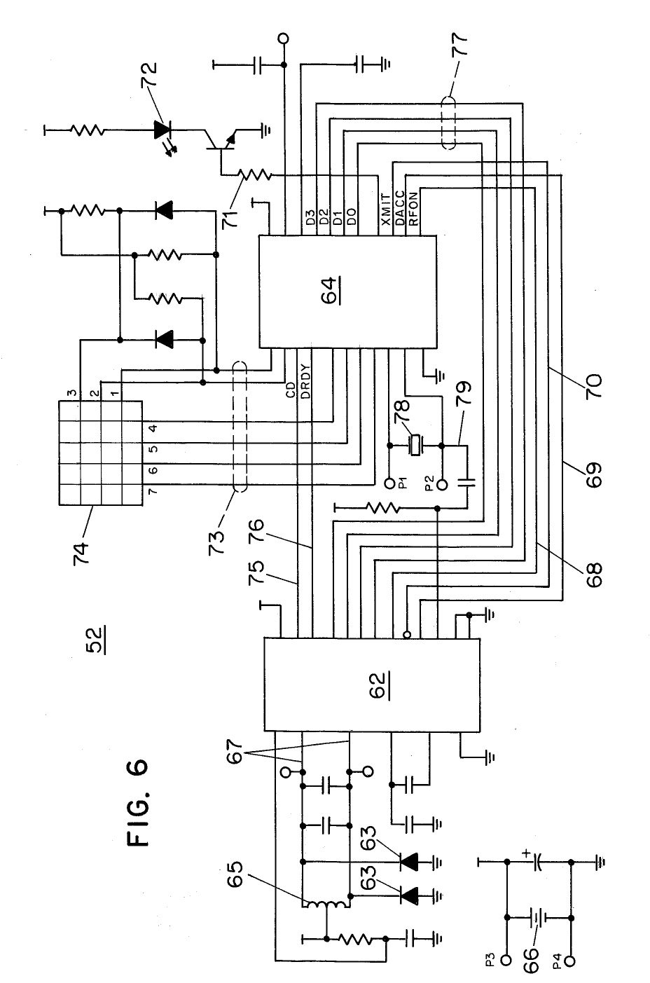

FIG. 4 shows a tagging and communication system 45 according to the invention, including disks and/or PCDs 53, 54, 55 such as shown in FIG. 3. This system 45 provides a way to monitor the inventory of disks and/or PCDs 53, 54, 55. In this system, location tags 52 are placed in a number of locations in a shelf area, so that each device 53, 54, 55 is nearby to one of the location tags 52. For example, in a retail store selling DVDs, the DVDs may be stacked face-out to the customer. With such a physical layout, the customer is able to see the face of the front-most DVD and other DVDs are behind the first one. At the back of the stack of DVDs is one of the location tags 52. The location tag 52 may be mechanically fixed to a shelf system for example by adhesive to the rear of the stacking area. The location tags can contain batteries if desired, since they do not have as many form-factor constraints as the merchandise items.

A typical store layout has gondolas. Each gondola has two faces or sides, each side facing an aisle where customers can walk. Each side of the gondola has several shelves, and each shelf has several stacking areas as mentioned above. If, as in an exemplary embodiment, the gondola face has five shelves and if each shelf has eight stacking areas, then there would be forty location tags on each face, one at the rear of each stacking area.

In a typical store layout there will not only be standalone gondolas but also shelf units against walls. A shelf unit will have a face that serves largely the same functions as one of the two faces of a gondola. In the discussion that follows, for convenience the term “gondola” will be used and it will often be a convenient shorthand to include wall shelf units and other ways of presenting merchandise.

Surrounding the face of the gondola is a loop antenna 46. The shape and size of the antenna is selected to fit conveniently on the periphery of the face of the gondola. The antenna is connected by wiring to a converter 48. Converter 48 accomplishes a number of functions, as detailed below.

The converter 48 emits RF energy which provides motive power to PCDs 31 (FIG. 1) to disks 42 (FIG. 3), which can comprise devices 53, 54, 55 (FIG. 4). In addition the converter 48 receives RF emissions from location tags 52.

The converter 48 may have an antenna 49 which links to a wireless local-area-network such as an 802.11g wireless network. In this way the converter 48 is in communication with a central host 51 which has its own antenna 50. (It will be appreciated that the communication between converter 48 and host 51 may instead be a wired ethernet connection or any other suitable connection and the particular choice of connection is not crucial.)

A most convenient way to provide the system in a retail store is to provide one converter 48 for each gondola. While the converter 48 will require AC power, it will not require a wired data connection if a wireless network is employed as mentioned above. There will thus be a plurality of converters 48 all in communication with host 51.

By means of the loop antenna 46, the converter 48 will also be able to exchange messages with active devices such as employee identification (ID) card 56 and customer loyalty or affinity card 57. It can also detect nearby passive communication devices 58.

It will be appreciated that the passive communication devices 31 (FIG. 1) and the disks 42 (FIG. 3) are only readable by means of antennas that are nearby. In the system of FIG. 4, the physical layout is selected so that each passive communication device 31 (FIG. 1) and each disk 42 (FIG. 3) (depicted in FIG. 4 as devices 53, 54, 55) is nearby to one of the location tags 52, close enough that it can be read. Each location tag 52 has a battery and a microcontroller and an antenna and thus is able to execute firmware so as to detect the presence or absence of nearby devices 53, 54, 55 and to read data stored therein. Each location tag 52 is then able to pass along information about the detected devices 53, 54, 55 to the converter 48 by means of its antenna. Each location tag 52 is also able to pass along information about tags 56, 57, 58 to the converter 48 by means of its antenna.

It will be appreciated that preferably each location tag 52 not only passes along to converter 48 the information that it has detected, but also appends information as to its own identity. In this way the information that reaches the converter 48 permits localizing a device 53, 54, 55 to within a range of locations nearby to a particular one of the location tags 52.

It will be appreciated that preferably each converter 48 not only passes along to host 51 the information that it has received from location tags 52, but also appends information as to its own identity. In this way the information that reaches the host 51 permits localizing a location tag 52 to within the antenna range of a particular converter 48.

In a prior-art system in which a reader reads a passive communications device such as devices 53, 54, 55, the reader needs to be nearby, and there is a further requirement, namely that the reader emits RF energy sufficient to power the device 53, 54, 55. This means the reader, if battery powered, will drain batteries fast because of the power needed to generate the RF energy needed to power the devices 53, 54, 55. In the present system, in contrast, the readers that read the devices 53, 54, 55 (namely the location tags 52) are not required to provide motive power for the devices 53, 54, 55. Instead, importantly, the loop 46 can provide such power to the devices 53, 54, 55.

In a variant of this approach, it could be set up that each device 53, 54, 55 is powered by a nearby location tag 52 rather than by the loop 46, and then each location tag 52 is in turn powered by the loop 46.

The large loop 46 is able to do “area reads,” meaning that it is able to read and communicate with active tags (tags having batteries) that are located anywhere within a large area. For example the loop 46 will be able to read and communicate with a location tag 52 that is located anywhere within the loop 46 or within several feet in front of or behind the loop 46. It will likewise be able to read and communicate with active tags such as cards 56, 57.

FIG. 4.1 shows the functional block diagram of converter 48 which provides for a Power Channel and a Communications channel.

At the top of the figure is the power channel 161 by which the converter 48 provides power to devices. The RF power signal is developed at test point 165. It passes through a trap 162 which traps the communication frequency (thereby preventing significant RF energy at the communications frequency to leak backwards (to the left) in FIG. 4.1, back into the power channel 161. The power signal passes through a bank 163 of (typical) five relay-selected capacitors. The purpose of the capacitors is to serve as an antenna tuner, maximizing SWR in the face of what may be an extremely unpredictable and variable antenna arrangement.

At the middle of the figure is the communications channel 171 by which the converter 48 provides data to devices. The RF communications signal is developed at test point 175. It passes through a trap 172 which traps the power frequency (thereby preventing significant RF energy at the power frequency to leak backwards (to the left) in FIG. 4.1, back into the communications channel 171. The communications signal passes through a somewhat similar bank 173 of (typical) five relay-selected capacitors. As with the power signal, the purpose of the capacitors in the data channel 171 is to serve as an antenna tuner, maximizing SWR.

At the bottom of the figure is the receiver 181 for the communications channel. The received RF energy is mixed at 182 with a carrier at the communications channel frequency, and is mixed at 183 with that same carrier phase-shifted by 90 degrees at 184. This provides a sine output 185 and a cosine output 186 to a microcontroller (omitted for clarity in FIG. 4.1) which is then more able to detect received data.

Returning to FIG. 1.1, there is a fusible link 128. The purpose of this link 128 is to provide a way in which the tag can behave in either of two different ways as the tag (and its associated merchandise) pass through a doorway such as that just described. If link 128 is intact, the tag will respond to an interrogation at the doorway with a predefined data (digital) signal indicative of merchandise that has not been paid for. If on the other hand the link 128 has been blown, the tag responds with a different signal indicative of merchandise that has been paid for. In this way it is possible to track, with high confidence, each tag as it passes through the doorway.

FIG. 6 shows in schematic form the hardware of the location tag 52. The tag 52 has an antenna 65 which in this example is a center-tapped coil of 22 turns in total, 33 gauge copper wire. Push-pull antenna lines 67 come from RF chip 62 to control the current through the antenna at times when the tag 52 is transmitting. These same antenna lines 67 are used when the chip 62 is acting as a receiver. Diodes 63 help to protect the RF chip 62 if it attempts to transmit at a time of extreme and unexpected coupling of the antenna 65 with external conductors. Tag 52 is powered by battery 66, typically a three-volt lithium watch battery.

RF chip 62 is controlled by microcontroller 64. The microcontroller 64 and RF chip 62 each receive an oscillator clock from crystal 78 which is typically a 32768-Hertz watch crystal. This clock signal can be quadrupled within RF chip 62 to yield a 131072-Hertz carrier frequency used for both transmit and receive.

An optional 3 by 4 keypad 74 can be connected with microcontroller 64 by means of key matrix lines 73. In a typical embodiment there is only one key (rather than twelve keys), the one key serving as a pushbutton.

An optional light-emitting diode (LED) 72 can be connected via drive line 71 to the microcontroller 64.

The microcontroller 64 turns on the RF chip 62 by means of RF ON line 68. The microcontroller 64 causes the RF chip 62 to shift from receive mode to transmit mode by means of transmit line 70. When the RF chip 62 detects an RF carrier at the antenna 65, it communicates this by means of a carrier-detect (CD) line 75. Bidirectional data lines 77 permit transmission of data, a four-bit nibble at a time, between the RF chip 62 and the microcontroller 64.

During receive mode, the data-ready line 76 is set high by the RF chip 62 to indicate that data is ready to be read by the microcontroller 64. The data-accept line 69 is pulsed high after each data is read by the microcontroller 64.

During transmit mode, the data-accept line 69 is pulsed high when each new data is presented to the RF chip 62. The data-ready line 76 is set high by the RF chip 62 to indicate that the RF chip 62 has read the data.

In a typical embodiment, the RF chip 62 is off the majority of the time, thus minimizing power consumption by the RF chip 62. Periodically the microcontroller 64 will power up the RF chip 62 and check the CD line 75 for the presence of received RF energy. If carrier is detected, the tag will remain in receive mode until an appropriate timeout period has elapsed, and then it returns to sleep mode.

A typical data format is AM-modulated biphase-coded at 1024 baud.

The microcontroller 64 contains a memory which is programmed with a unique identifier. If the converter 48 wishes to communicate with a particular tag 52 it can do so by including that unique identifier in a message being sent from the converter 48 to the tag 52. The many tags 52 each receive such a message, and each one passes the message from its RF chip 62 to its microcontroller 64. Each microcontroller 64 then inspects the message to see if the message is intended for the tag 52 of that particular microcontroller 64.

An important aspect of the system 45 is that a converter 48 will wish to be able to identify location tags 52 which have newly entered or exited its reading area. Likewise a location tag 52 may wish to be able to identify devices 53, 54, 55 which have newly entered or exited its reading area. (The latter reading area is, as discussed above, much smaller than the former reading area.) When a converter 48 wishes to identify location tags 52 that are within its area, it will send a broadcast message (sometimes called a “global read” message) that awakens all of the tags 52. It can then ask for a response from one of the tags 52. When the response is successfully read, the tag 52 whose response was read will be told to sleep for some fixed interval, or until the “sleep” state is reset, for example by removing the power RF signal. During this time another broadcast is made and another tag 52 will respond. Eventually all of the tags in the reading area for the converter 48 will have been identified.

In a similar way the converter 48 may learn that an ID card 56 has entered or exited the reading area, or that a customer loyalty card 57 has entered or exited the reading area.

Again, each location tag 52 will from time to time wish to identify devices 53, 54, 55 which have newly entered or exited its reading area. It will be appreciated that the devices 53, 54, 55 are powered by energy from the loop 46 and can respond to interrogations from the location tags 52. In this way an inventory can be enumerated as to the devices 53, 54, 55 which have entered or exited the reading area for a particular location tag 52.

It is important to appreciate that the bandwidth available in the retail store is much higher than 1024 bits per second. For one thing, each loop 46 has a limited volume in which to receive and transmit, and thus loops 46 that are at some distance from each other will each have the full bandwidth available to any one loop 46. If the number of loops 46 is N, then the bandwidth available through the store as a whole will be theoretically as much as N times 1024 baud, although more realistically it will be some fraction of that product.

In addition, it will be appreciated that the reading area for a particular location tag 52 is much smaller (as mentioned above) then the reading area for a loop 46. Thus, during a time when no data are being communicated through the loop 46, each location tag 52 can use the entire RF bandwidth (here, 1024 Hertz) to communicate with “its” devices 53, 54, 55, that is, the devices within its reading area. Thus the theoretical bandwidth during times when the loops 46 are quiescent (only emitting RF power but not any data modulations) can approach M times 1024 baud, where M is the number of location tags 52.

Desired Functional Characteristics

A typical (traditional) passive RFID tag polling system relies on a cumbersome anti-collision methodology. Each time a set of tags is polled by a reader, all tags in the field respond to the poll transmission, each with a random time delay to their response. 100% of the tags must respond on each (subsequent) poll transmission until all tags in the field have been identified. This “re-discovering” step severely limits the maximum number of tags which may be polled due the cumulative time delay of the random responses. As each tag responds and is identified in each poll, those same identified tags continue to respond on the next polls—thereby randomly preventing an as-yet-unidentified tag from being heard by the reader. Specifically a means is required to inhibit a previously identified tag from responding to a general poll.

A second common requirement for an ID tag is the ability to respond to a tag specific poll. This is a poll specifically addressed to one ID tag. By itself this function is very desirable for doing inventory control, but if one adds the ability to inhibit the response to a general poll after addressing a tag in this manner it is possible to implement a very simple and efficient anti-collision system. To do this one simply performs a general poll and as tags get discovered they are added to a list of tags that are specifically addressed before the next general poll.

On the surface these requirements may seem very simple, but for a passive ID tag they are very difficult to implement. By definition a passive ID tag is passive and has power available only during communication. Generally each time the reading field is applied an ID tag wakes up in the same reset condition. Remembering a state during a period of non-communication will require the use of EEPROM or by the creative use of capacitors. Both of these methods have their own pros and cons. A second less obvious problem is in the ability to decode data in the tag. In order to perform an ID specific read, a clock must be available to drive the internal logic in order to compare the received signal to the preprogrammed ID. The problem is that this clock is absent part of the time if AM modulation is employed to communicate with the tag. A second time reference (clock or timer) is required to decode the modulation. Both of these problems can be address by adding a second carrier channel specifically used to power the tag, as discussed above.

A third requirement of an ID tag is the ability to be used in an Electronic Article Surveillance system (EAS). Generally, it is not required to know the ID of a tag in these systems, merely that a tag is present in a detection zone. Therefore it is desirable to use a code or ID that is common to all tags. In fact one can pick a code that has desirable signal processing properties (PSN). These codes are used in spread-spectrum transmission systems and are well known for their abilities in creating more sensitive receivers and therefore a more reliable systems. This fixed code will be referred to as the EAS code. One more item is required for an EAS tag, namely the ability to disable the response to a general poll by a security bit. During the check out procedure this bit is blown by some means inhibiting the tag from responding to Global ID polls, as described above with respect to fusible link F1 in FIG. 1.1.

A tag can thus do the following:

(1) Respond to a general poll with:
a) read back ID with some primitive anti collision, or
b) read back EAS code
   (The communication protocol must contain a means of selecting which response to initiate.)

(2) Respond to tag-specific poll by reading back the ID and inhibiting responding to a general poll for;
a) some period of time, or
b) a number of communication cycles.

The tag preferably contains a fuse bit or switch (e.g. the fusible link F1 mentioned above) to disable the response of EAS, or better still to change the EAS code after blowing.

Implementation

A simple method for achieving the short-term data storage required for specific polling is to have a second, independent means of providing RF power to the circuit (for example through coil L1 as discussed above). This channel can not only provide power to the circuit during periods of no communication but also provide a clock reference for logic to decode the communication channel (provided through coil L2 as discussed above). Framing and other special functions can be also be controlled by this channel. Another incidental benefit is provided by the fact this channel is not used for data communications and is only a carrier wave channel. The regulatory rules for such a channel can be quite different then the rules for a communication channel.

Two options exist for the frequency of this channel. It can be higher then the communication channel or lower than the communication channel. Both methods have some merits.

If the power channel is higher in frequency then the communication channel the return transmission frequency is easily derived by dividing by a binary number.

If the power channel is lower in frequency then the communication channel then coil impedances work out a little better for better return signal amplitude.

To effectively use a two-channel system the ID tag must contain two coils tuned to the two respective frequencies. To make the circuit design simpler it is desirable to arrange these coils physically so that the magnetic field coupling between these coils is minimized. In such an arrangement both channel are electrically independent. Power placed in the communication channel during return polling will not interfere with the clock signal in the power channel, thus simplifying the design of iDot chip. It is very difficult, however, to arrange two coils to have no magnetic coupling. Normally, to accomplish such an absence of coupling, the coils must be at right angles to each other and/or have ferrite cores. This adds cost and size to such a system. A better approach, then, is to electronically separate the frequencies inside the chip. This allows the use of two closely coupled tuned circuits such as a center-tapped planer air-wound coil such as that described above for coils L1 and L2, which is a simple and inexpensive coil to construct.

1. Apparatus comprising:
a circular data-bearing medium;
the circular data-bearing medium having a hub hole;
the circular data-bearing medium having an integrated circuit chip and no battery;
the circular data-bearing medium having first and second loop antennas;
each of the first and second loop antennas offset from the other,
each of the first and second loop antennas disposed around the hub hole,
the integrated circuit chip electrically connected with each of the two distinct antennas.

2. The apparatus of claim 1 wherein the a circular data-bearing medium comprises a compact disk.

3. The apparatus of claim 1 wherein the a circular data-bearing medium comprises a digital video disk. The apparatus of claim 1 wherein the a circular data-bearing medium comprises a CD-ROM.

4. A method for use with a store and with a multiplicity of items of merchandise, each item comprising a respective integrated circuit chip, each item comprising first and second loop antennas, each of the first and second loop antennas electrically connected with the integrated circuit chip, the integrated circuit chip not powered by a battery, the integrated circuit chip defining at least on internal state, each item comprising a blowable link communicatively coupled with the integrated circuit chip, the store having an exit and having a sensor nearby to the exit, the method comprising the steps of:
bathing the items in RF energy, thereby providing power to the respective integrated circuit chip by means of the first of the loop antennas of each item;
transmitting messages;
at each of the items, receiving the messages at the second of the loop antennas;
at each of the items, responding, by means of the second antenna, to some of the received messages and not others, based upon the at least one internal state within the chip;
at each of the items, resetting the at least one internal state upon loss and restoration of the bathing RF energy;
at each of the items, if nearby to the sensor, selectively either triggering the sensor or not triggering the sensor, as a function of whether the respective link has or has not been blown;
the triggering of the sensor comprising communicating a response from the triggering item, the response being non-identical from one item of merchandise to the next.

5. An item of merchandise comprising:
an integrated circuit chip not powered by a battery;
the item of merchandise having first and second loop antennas, each of the two distinct loop antennas offset from the other, the integrated circuit chip electrically connected with each of the two distinct antennas;
the item of merchandise further comprising a blowable link;
the integrated circuit chip responsive to RF energy bathing the first of the loop antennas for providing power to the integrated circuit chip;
the integrated circuit chip responsive, when powered, to messages received at the second of the loop antennas;
the integrated circuit chip responsive to some of the received messages and not others, based upon at least one internal state within the chip and based upon whether or not the blowable link is blown;
the integrated circuit chip responsive to loss and restoration of the bathing RF energy by resetting the at least one internal state.

6. A multiplicity of items of merchandise, each item of merchandise comprising:
an integrated circuit chip not powered by a battery;
each item of merchandise having first and second loop antennas, each of the two distinct loop antennas offset from the other, the integrated circuit chip electrically connected with each of the two distinct antennas;
each item of merchandise further comprising a blowable link;
each integrated circuit chip responsive to RF energy bathing the first of the loop antennas for providing power to the integrated circuit chip;
each integrated circuit chip responsive, when powered, to messages received at the second of the loop antennas;
each integrated circuit chip responsive to some of the received messages and not others, based upon at least one internal state within the chip and based upon whether or not the blowable link is blown;
each integrated circuit chip responsive to loss and restoration of the bathing RF energy by resetting the at least one internal state;
the items of merchandise each, when responding with its blowable link not blown, responding differently from each other.
